(19) United States
(12) Patent Application Publication
(10) Pub. No.: US 2006/0097778 A1
(43) Pub. Date: May 11, 2006

(54) Differential amplifier with high voltage gain and stable common mode output voltage

(76) Inventor: Hyuk-Joon Kwon, Gyeonggi-do (KR)

Correspondence Address: MYERS BIGEL SIBLEY & SAJOVEC, PO BOX 37428, RALEIGH, NC, 27627, US

(21) Appl. No.: 11/259,575

(22) Filed: Oct. 26, 2005

(30) Foreign Application Priority Data
Nov. 5, 2004 (KR) 10-2004-89549

(51) Int. Cl. G06G 7/12

(52) U.S. Cl. 327/560

(57) ABSTRACT

Disclosed is a differential amplifier having a high voltage gain and a stable common-mode output voltage. The differential amplifier is comprised of a signal loading circuit to regulate the amount of currents flowing through first and second signal output terminals. The signal loading circuit includes first and second loading diodes to regulate the amount of currents flowing each to the first and second output terminals from a power source voltage, and a loading source to regulate current amount flowing from the power source voltage to the second signal output terminal in response to the first signal output signal. The differential amplifier is characterized with a high voltage gain for a small signal, generating a stable common-mode output voltage against variation of a common-mode voltage of input voltages as well.

### CROSS-REFERENCE TO RELATED APPLICATION

This application claims priority to Korean Patent Application No. 2004-89549, filed Nov. 5, 2004, the disclosure of which is hereby incorporated herein by reference.

### BACKGROUND

The present invention is concerned with amplifiers, which in particular relates to a differential amplifier sensing and amplifying a voltage difference among signals received thereto.

Differential amplifiers generally have amplifying components (e.g., transistors) cross-coupled to each other, and loading components connected between a power source voltage and output terminals thereof. Two input signal are applied the amplifying components receive two input signals, and two output signals are generated from the output terminals. A voltage difference between the output signals is amplified with a voltage difference between the input signals. Such a differential amplifier needs to be operable with a stable condition nevertheless of variations in temperature and voltage level supplied from the external.

FIG. 1 is a circuit diagram of a conventional differential amplifier 10. In the differential amplifier 10 of FIG. 1, two loading components MP11 and MP12 are constructed in circuit patterns of diodes. The differential amplifier 10 is normally designed to generate a common-mode output voltage of output signals VOUTK1 and VOUTK2, which is relatively stabilized, from variation of a common-mode voltage level of input signals VINK1 and VINK2. However, the circuit construction with the diode-connected loading components MP11 and MP12 as a whole may limit an amplifying voltage level of the output signals VOUTK1 and VOUTK2. As a result, the conventional differential amplifier 10 shown in FIG. 1 is ineffective to obtain a sufficient small-signal voltage gain.

FIG. 2 examples another conventional differential amplifier 20. In the differential amplifier 20 of FIG. 2, while one of two loading components MP21 and MP22, MP21, is constructed in diode connection, the other loading component MP22 is arranged as a current source. The differential amplifier 20 is effective in obtaining a high small-signal voltage gain because of the loading component MP22 acting as a current source. However, the differential amplifier 20 has a disadvantage that a common-mode voltage level of the output signals VOUTL1 and VOUTL2 varies with a great deal in accordance with variations of its input signals VINL1 and VINL2.

### SUMMARY OF THE INVENTION

A differential amplifier according to embodiments of the invention provides first and second output signals having a voltage reference amplified from a voltage gap between first and second input signals. The differential amplifier is comprised of a signal output circuit, an input responding circuit, and a signal loading circuit. The signal output circuit includes first and second signal output terminals. The first signal output terminal provides the first output signal, while the second signal output terminal provides the second output signal. The input responding circuit, which is disposed between the signal output circuit and a first voltage supply terminal, drives the first and second output signals to generate the amplified voltage difference in response to the first and second input signals. The signal loading circuit, which is disposed between a second voltage supply terminal and the signal output circuit, regulates the amount of currents flowing into the first and second signal output terminals. The signal loading circuit includes first and second loading diodes, and a loading source. The first loading diode regulates current amount flowing from the second voltage supply terminal to the first signal output terminal in response to the first output signal. The second loading diode regulates current amount flowing from the second voltage supply terminal to the second signal output terminal in response to the second output signal. The loading source regulates current amount flowing from the second voltage supply terminal to the second signal output terminal in response to the first output signal. And, an element, through which a current amount is regulated in accordance with variation in a voltage level of the second output signal, is excluded, the element being formed between the first signal output terminal and the second voltage supply terminal.

In a preferred embodiment, the second voltage supply terminal has a voltage higher than that of the first voltage supply terminal. The first loading diode is a first P-type transistor connected between the second voltage supply terminal and the first signal output terminal. The current in the first P-type is controlled by the first output signal. The second loading diode is a second P-type transistor connected between the second voltage supply terminal and the second signal output terminal. The current in the second P-type transistor is controlled by the second output signal. The loading source is a third P-type transistor connected between the second voltage supply terminal and the second signal output terminal. The current in the third P-type transistor is controlled by the first output signal.

In another preferred embodiment, the second voltage supply terminal has a voltage lower than that of the first voltage supply terminal. The first loading diode is a first N-type transistor connected between the second voltage supply terminal and the first signal output terminal. The current in the first N-type transistor is controlled by the first output signal. The second loading diode is a second N-type transistor connected between the second voltage supply terminal and the second signal output terminal. The current in the second N-type transistor is controlled by the second output signal. The loading source is a third N-type transistor connected between the second voltage supply terminal and the second signal output terminal. The current in the third N-type transistor is controlled by the first output signal.

Additional embodiments of the invention include a differential amplifier having first and second MOS input transistors responsive to first and second input signals. A current source is also provided. The current source is electrically connected to source terminals of the first and second MOS input transistors. A load circuit of the differential amplifier is electrically coupled to drain terminals of the first and second MOS input transistors, which represent output terminals of the differential amplifier. This load circuit may include a first MOS load transistor having gate and drain terminals electrically connected to a drain terminal of the first MOS input transistor and a source terminal configured to receive a power supply voltage. The load circuit also includes a second MOS load transistor having a gate terminal electrically connected to the drain terminal of the first MOS input transistor, a drain terminal electrically connected to a drain terminal of the second MOS input transistor and a source terminal configured to receive the power supply voltage. A third MOS load transistor is also provided within the load circuit. The third MOS load transistor has gate and drain terminals electrically connected to the drain terminal of the second MOS input transistor and a source terminal configured to receive the power supply voltage.

### BRIEF DESCRIPTION OF THE DRAWINGS

The accompanying drawings are included to provide a further understanding of the invention, and are incorporated in and constitute a part of this specification. The drawings illustrate example embodiments of the present invention and, together with the description, serve to explain principles of the present invention. In the drawings:

FIG. 1 is a circuit diagram of a conventional differential amplifier;

FIG. 2 is a circuit diagram of another conventional differential amplifier;

FIG. 3 is a circuit diagram illustrating a differential amplifier according to a preferred embodiment of the present invention;

FIG. 4 is a graphic diagram comparatively showing output signals of differential amplifiers by the conventional and present invention;

FIG. 5 is a circuit diagram illustrating a differential amplifier according to another embodiment of the present invention; and

FIG. 6 is a circuit diagram illustrating a differential amplifier according to a comparative embodiment of the present invention.

### DETAILED DESCRIPTION OF PREFERRED EMBODIMENTS

Preferred embodiments of the present invention will be described below in more detail with reference to the accompanying drawings. The present invention may, however, be embodied in different forms and should not be constructed as limited to the embodiments set forth herein. Rather, these embodiments are provided so that this disclosure will be thorough and complete, and will fully convey the scope of the invention to those skilled in the art. Like numerals refer to like elements throughout the specification.

Hereinafter, it will be described about an exemplary embodiment of the present invention in conjunction with the accompanying drawings.

In this specification, ‘common mode voltage’ means the middle point of voltage in any swinging signal.

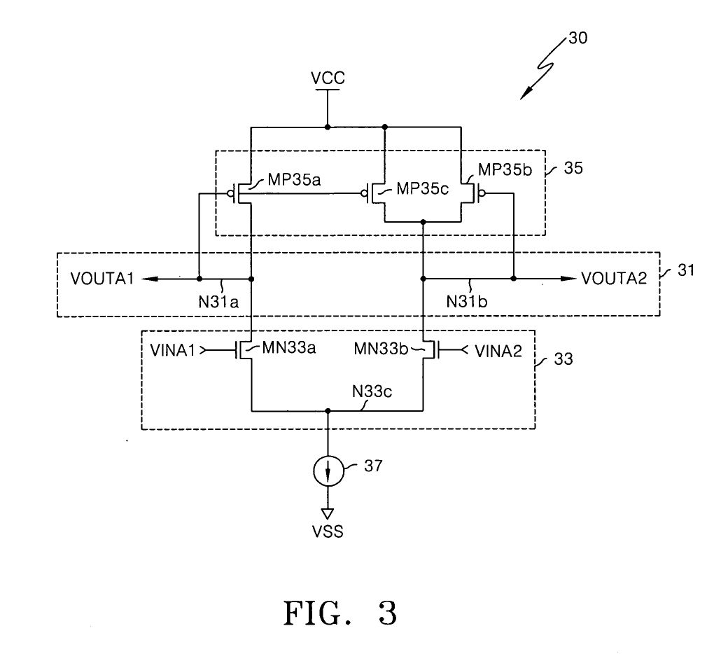

FIG. 3 illustrates a differential amplifier 30 according to a preferred embodiment of the present invention. Referring to FIG. 3, the differential amplifier 30 receives first and second input signals, VINA1 and VINA2, and then generates first and second output signals VOUTA1 and VOUTA2. By the differential amplifier 30, a voltage difference between the first and second input signals VINA1 and VINA2 is amplified to be a voltage difference of the first and second output signals VOUTA1 and VOUTA2. The voltage difference between the first and second input signals VINA1 and VINA2 is referred to as “input voltage difference”, while the voltage difference between the first and second output signals VOUTA1 and VOUTA2 is referred to as “output voltage difference”. In other words, the output voltage difference is transformed with a predetermined small-signal voltage gain from the input voltage difference due to the differential amplifier 30.

In this embodiment, while the output voltage difference is polarized reverse to the input voltage difference, it is just figured out dependent on arrangements of the input and output signals, which is modifiable not specific in the present invention.

The differential amplifier 30 is comprised of a signal output circuit 31, an input responding circuit 33, and a signal loading circuit 35. The signal output circuit 35 generates the first and second output signals VOUTA1 and VOUTA2 each through first and second signal output terminals N31a and N31b.

The input responding circuit 33 is connected between the signal output circuit 31 and a ground voltage VSS. The ground voltage Vss may be referred to as “first voltage supply terminal”. The input responding circuit 33 is controlled in response to the first and second input signals VINA1 and VINA2.

In detail, the input responding circuit 33 includes N-type transistors MN33a and MN33b, and a common source terminal N33c. The common source terminal N33c is supplied with current from the first voltage supply terminal (i.e., the ground voltage VSS). The N-type transistor MN33a is connected between the first signal output terminal N31a and the common source terminal N33c. The flowing current in the N-type transistor MN33a is controlled by the first input signal VINA1. The N-type transistor MN33b is connected between the second signal output terminal N31b and the common source terminal N33c. The flowing current in the N-type transistor MN33b is controlled by the second input signal VINA2.

Preferably, the N-type transistor MN33a is an NMOS transistor that is conductively gated by the first input signal VINA1 and the N-type transistor MN33b is also an NMOS transistor that is gated by the second input signal VINA2.

The input responding circuit 33 constructed as aforementioned drives the first and second output signals, VOUTA1 and VOUTA2, to generate the output voltage difference amplified from the input voltage difference. Here, a ratio of amplifying from the input voltage difference to the output voltage difference is determined dependent on a ratio of currents flowing through the N-type transistors, MN33a and MN33b, and P-type transistors MP35b and MP36c those will be described later.

The signal loading circuit 35 is disposed between the power source voltage VCC and the second signal output terminal N31b, in order to control currents flowing into the first and second output terminals N31a and N31b. The embodied feature shown in FIG. 3, the power source voltage VCC may be referred to as “second voltage supply terminal”. The power source voltage VCC is higher than the ground voltage VSS.

In detail, the signal loading circuit 35 is comprised of a first loading diode MP35a, a second loading diode MP35b, and a loading source MP35c. The first loading diode MP35a regulates the amount of current flowing from the second voltage supply terminal (i.e., VCC) and the first signal output terminal N31a in response to a voltage level of the first output signal VOUTA1. The second loading diode MP35b regulates the amount of current flowing from the second voltage supply terminal (i.e., VCC) and the second signal output terminal N31b in response to a voltage level of the second output signal VOUTA2. As such, the first and second loading diodes, MP35a and MP35b, are implemented in the circuit pattern of diode connection. Therefore, the differential amplifier 30 regulates a common-mode voltage of the first and second output signals, VOUTA1 and VOUTA2, almost in a constant level for DC voltage variation of the first and second input signals VINA1 and VINA2.

Further, the loading source MP35c controls the amount of current flowing from the second voltage supply terminal VCC and the second signal output terminal N31b in response to a voltage level of the first output signal VOUTA1. In other words, the loading source MP35c functions as a source supplying a current, not a diode as like MP35a or MP35b. As a result, the loading source MP35c as a current source contributes to render the differential amplifier 30 to give a higher small-signal voltage gain.

Preferably, the first loading diode MP35a is a P-type transistor connected between the second voltage supply terminal VCC and the first signal output terminal N31a, and the second loading diode MP35b is a P-type transistor connected between the second voltage supply terminal VCC and the second signal output terminal N31b. The loading source MP35c is a P-type transistor connected between the second voltage supply terminal VCC and the second signal output terminal N31b.

More preferably, the first loading diode MP35a is a PMOS transistor having a source electrode connected to the second voltage supply terminal VCC, and drain and gate electrodes connected to the first signal output terminal N31a in common. The second loading diode MP35b is a PMOS transistor having a source electrode connected to the second voltage supply terminal VCC, and drain and gate electrodes connected to the second signal output terminal N31b in common. The loading source MP35c is a PMOS transistor having a source electrode connected to the second voltage supply terminal VCC, a gate electrode connected to the first signal output terminal N31a, and a drain electrode connected to the second signal output terminal N31b.

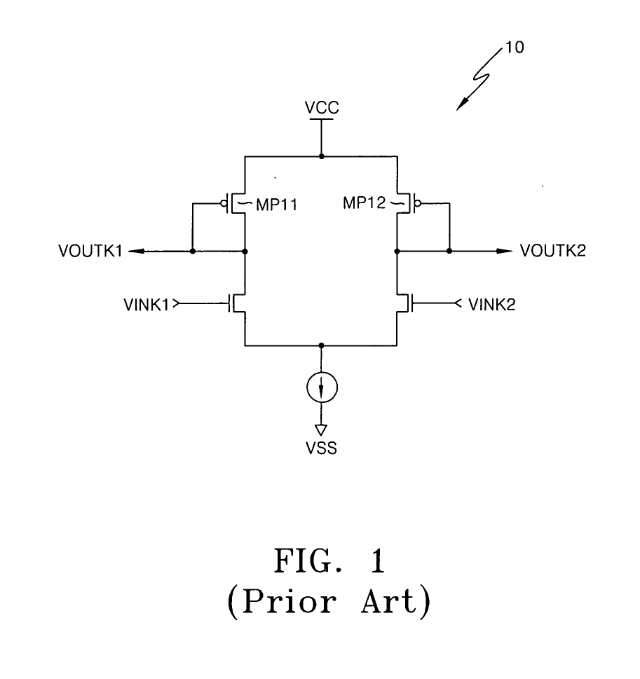

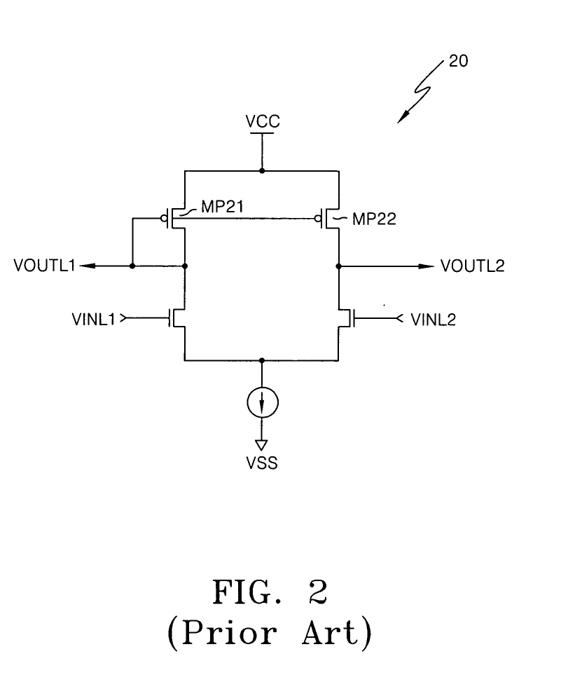

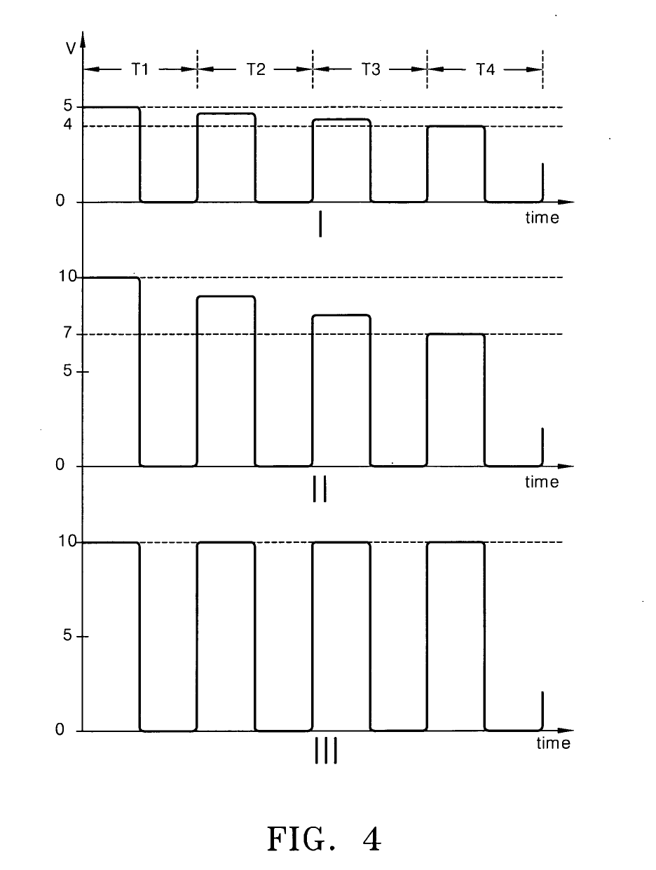

Continuously, the differential amplifier according to the present invention will be compared with the conventional in effect. FIG. 4 is a graphic diagram comparatively showing output signals of differential amplifiers by the conventional and present invention. In FIG. 4, the graph I plots waveforms of the output signals generated from the conventional differential amplifier shown in FIG. 1. The graph II plots waveforms of the output signals generated from the conventional differential amplifier shown in FIG. 2. The graph III plots waveforms of the output signals generated from the differential amplifier according to the present invention shown in FIG. 1.

In the intervals T1, T2, T3, and T4 of FIG. 4, common-mode voltage levels of the input signals VINK1/VINK2, VINL1/VINL2, and VINA1/VINA2 are 1V, 1.5V, 2V, and 2.5V, respectively.

Comparing the output signal waveforms in view of small-signal voltage gain, the differential amplifier 30 of the present invention has a small-signal voltage gain remarkably higher than the conventional differential amplifier 10 (compare I with III). Also, even with the conventional differential amplifier 20 shown in FIG. 2, the differential amplifier 30 of the present invention has a small-signal voltage gain more improved than the conventional differential amplifier 20 (compare II with III).

Next, considering the stability in the common-mode voltage of the second output signal, the differential amplifier 30 of the present invention has the stability of common-mode voltage remarkably improved than the conventional differential amplifier 20 (compare II with III). The common-mode voltage of the second output signal VOUTL2 by the conventional differential amplifier 20 sensitively responds to variations of common-mode voltage levels of the input signals. On the other hand, the common-mode output voltage of the second output signal VOUTA2 in the differential amplifier 30 of the present invention is maintained with stability, even when common-mode voltage level of the input signals is changed. Also, even with the conventional differential amplifier 10 shown in FIG. 1, the differential amplifier 30 of the present invention has the stability of common-mode voltage characteristic in the second output signal VOUT2, being more improved than the conventional differential amplifier 10 (compare I with III).

In summary, the signal loading circuit 35 of the differential amplifier 30 includes the loading source MP35c in the form of current source, together with the diode-coupled loading diodes MP35a and MP35b. Thus, the signal loading circuit 35 makes it possible to generate a high small-signal voltage gain and a stable common-mode output voltage.

Returning to FIG. 3, it is preferred for the differential amplifier 30 to further comprise a current bias source 37. The current bias source 37 controls a predetermined current to flow through the common source terminal N33c. The current bias source also contributes to enhancing a higher small-signal voltage gain and to generating a more stable common-mode output voltage of the output signals VOUTA1 and VOUTA2.

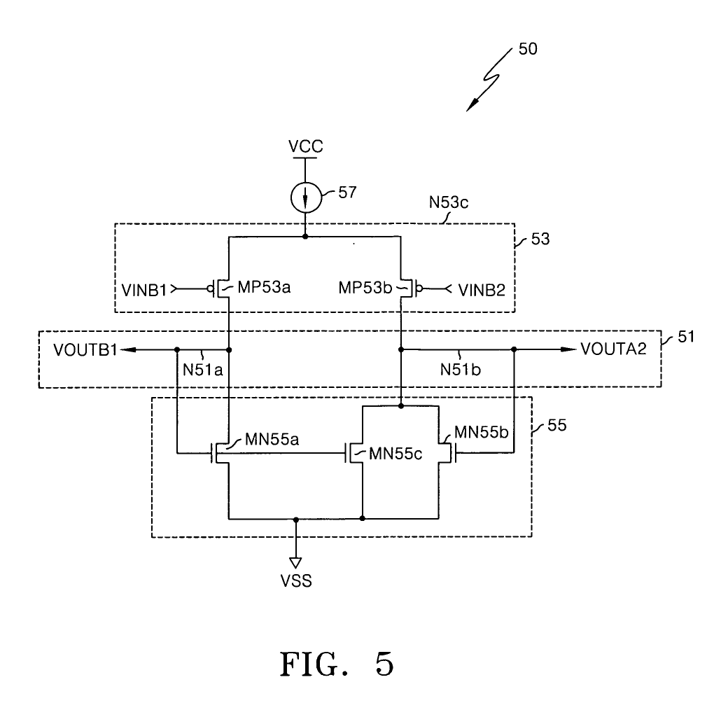

FIG. 5 illustrates a differential amplifier 50 according to another embodiment of the present invention. The differential amplifier 50 is similar to the differential amplifier 30 of FIG. 3 in the circuit construction and functional effect, but the operational polarities of the components.

In detail, P-type transistors, MP53a and MP53b, of an input responding circuit 53 in the differential amplifier 50 act as being similar to the N-type transistors MN33a and MN33b of the input responding circuit 33 in the differential amplifier 30 shown in FIG. 3. N-type transistors, MN55a, MN55b, and MN55c, of an signal loading circuit 55 in the differential amplifier 50 act as being similar to the P-type transistors, MP35a, MP35b, and MN35c, of the signal loading circuit 35 in the differential amplifier 30 shown in FIG. 3. And, it is preferred for the P-type transistors MP53a and MN53b to be implemented with PMOS transistors, and for the N-type transistors to be with NMOS transistors.

The practical circuit structure and operations of the differential amplifier 50 shown in FIG. 5 could be easily understood with reference to those descriptions relevant to the differential amplifier 30 of FIG. 3, so it will not be described about those items in detail.

In the differential amplifier 30 of FIG. 3, there is no element, through which a current amount is regulated in accordance with variation in a voltage level of the second output signal. There is no element, in the differential amplifier 30 of FIG. 3, which is formed between the first signal output terminal and the second voltage supply terminal.

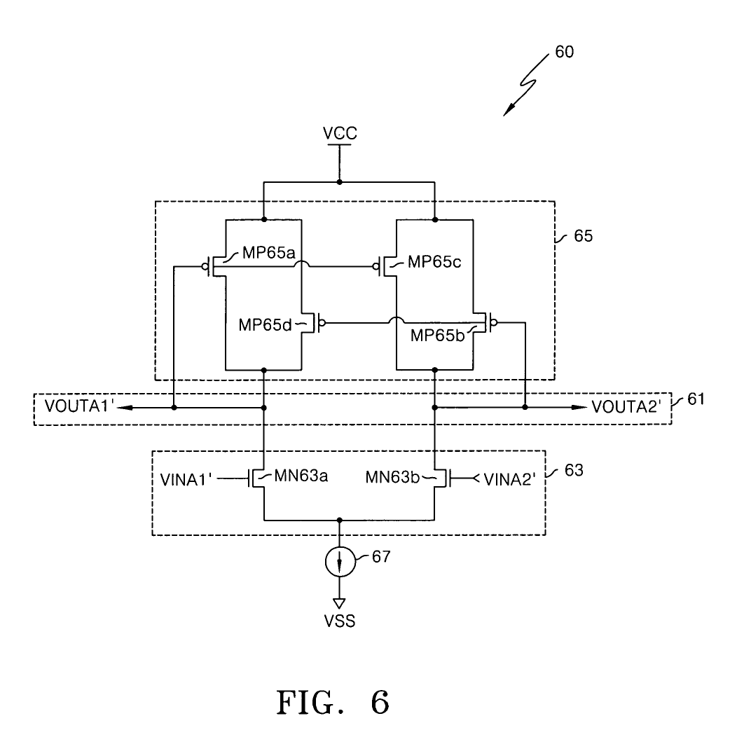

In this case, the differential amplifier 30 of FIG. 3 has advantage in operational stability of the common-mode voltage, relative to the differential amplifier 60 of FIG. 6.

FIG. 6 is a circuit diagram illustrating a differential amplifier according to a comparative embodiment of the present invention. A differential amplifier 60 illustrated in FIG. 6 is also similar to the differential amplifier 30 shown in FIG. 3, but a P-type transistor MP65d is further included in a signal loading circuit 65 thereof.

In the differential amplifier 30 of FIG. 3, when there is a factor to down the common-mode voltage of the second output signal VOUTA2, the current amount through the P-type transistor MP35b increases to lessen a drop in the common-mode voltage of the second output signal VOUTA2. As also, in the differential amplifier 30 of FIG. 3, when there is a factor to raise the common-mode voltage of the second output signal VOUTA2, the current amount through the P-type transistor MP35b increases to restrain an increase in the common-mode voltage of the second output signal VOUTA2.

Otherwise, in the differential amplifiers 60, when there is a factor to down the level of the common-mode voltage of a second output signal VOUTA2′, a current through the P-type transistor MP65d, as well as through the P-type transistor MP35d, increases. Thus, the voltage level of a first output signal VOUTA1′ increases to reduce the amount of current flowing through the P-type transistor MP65c, resulting in falling down the common-mode voltage of the second output signal VOUT2′.

As also, in the differential amplifier 60, even when there is a factor to raise the common-mode voltage of the second output signal VOUTA2′, it results in an increase of the common-mode voltage of the second output signal VOUTA2′.

In summary, the differential amplifier 30 according to the embodiment shown in FIG. 3 has highly better than the differential amplifier 60 according to the comparative one of FIG. 6 in operational stability of the common-mode voltage.

Although the present invention has been described in connection with the embodiments of the present invention illustrated in the accompanying drawings, it is not limited thereto. It will be apparent to those skilled in the art that various substitution, modifications and changes may be thereto without departing from the scope and spirit of the invention. For instance, while the aforementioned embodiments employ MOS transistors as the loading diodes, it may be applicable with bipolar transistors for the entire or partial diodes by those skilled in the art.

As stated above, the differential amplifier according to the invention is comprised of the signal loading circuit to regulate the amount of currents flowing towards the first and second signal output terminals, the first and second loading diodes to each regulate the amount of currents flowing from the second voltage supply terminal to the first and second signal output terminals, and a loading source to regulate the amount of current flowing from the second voltage supply terminal to the second signal output terminal. The two loading diodes are advantageous to generate a stable common-mode output voltage for output signals of the differential amplifier, even when a common-mode voltage level of input signals is changed. Moreover, the loading source is effective in enhancing a small-signal voltage gain of the differential amplifier.

As a result, the differential amplifier of the present invention has a higher small-signal voltage gain, as well as a more stable common-mode output voltage to variation on a common-mode voltage of input signals thereof.

Accordingly, as described above, the embodiment of the invention illustrated by FIG. 3 represents a differential amplifier 30 having first and second MOS input transistors (MN33a, MN33b) responsive to first and second input signals (VINA1, VINA2). A current source 37 is also provided. As illustrated, the current source 37, which may be of conventional design and defined by a plurality of MOS transistors (not shown), is electrically connected to source terminals of the first and second MOS input transistors (MN33a, MN33b). A load circuit 35 of the differential amplifier 30 is electrically coupled to drain terminals of the first and second MOS input transistors, which represent output terminals VOUTA1 and VOUTA2. In some embodiments, this load circuit 35 includes a first MOS load transistor (MP35a) having gate and drain terminals electrically connected to a drain terminal of the first MOS input transistor (MN33a) and a source terminal configured to receive a power supply voltage (e.g., Vcc). The load circuit 35 also includes a second MOS load transistor (MP35c) having a gate terminal electrically connected to the drain terminal of the first MOS input transistor (MN33a), a drain terminal electrically connected to a drain terminal of the second MOS input transistor (MN33b) and a source terminal configured to receive the power supply voltage. A third MOS load transistor (MP35b) is also provided within the load circuit 35. The third MOS load transistor has gate and drain terminals electrically connected to the drain terminal of the second MOS input transistor (MN33b) and a source terminal configured to receive the power supply voltage.

In addition, the embodiment of the invention illustrated by FIG. 5 represents a differential amplifier 50 having first and second MOS input transistors (MP53a, MP353b) responsive to first and second input signals (VINB1, VINB2). A current source 57 is also provided. As illustrated, the current source 37, which may be of conventional design and defined by a plurality of MOS transistors (not shown), is electrically connected to source terminals of the first and second MOS input transistors (MP53a, MN53b). A load circuit 55 of the differential amplifier 50 is electrically coupled to drain terminals of the first and second MOS input transistors, which represent output terminals VOUTB1 and VOUTB2. In some embodiments, this load circuit 55 includes a first MOS load transistor (MN55a) having gate and drain terminals electrically connected to a drain terminal of the first MOS input transistor (MP53a) and a source terminal configured to receive a power supply voltage (e.g., Vss). The load circuit 55 also includes a second MOS load transistor (MN55c) having a gate terminal electrically connected to the drain terminal of the first MOS input transistor (MP53a), a drain terminal electrically connected to a drain terminal of the second MOS input transistor (MP53b) and a source terminal configured to receive the power supply voltage. A third MOS load transistor (MN55b) is also provided within the load circuit 55. The third MOS load transistor has gate and drain terminals electrically connected to the drain terminal of the second MOS input transistor (MP53b) and a source terminal configured to receive the power supply voltage.

In the drawings and specification, there have been disclosed typical preferred embodiments of the invention and, although specific terms are employed, they are used in a generic and descriptive sense only and not for purposes of limitation, the scope of the invention being set forth in the following claims.

What is claimed is:

1. A differential amplifier providing first and second output signals having a voltage reference amplified from a voltage gap between first and second input signals, the differential amplifier comprising:
a signal output circuit including first and second signal output terminals, the first signal output terminal providing the first output signal, the second signal output terminal providing the second output signal;
an input responding circuit, which is disposed between the signal output circuit and a first voltage supply terminal, driving the first and second output signals to generate the amplified voltage difference in response to the first and second input signals; and
a signal loading circuit, which is disposed between a second voltage supply terminal and the signal output circuit, regulating the amount of currents flowing into the first and second signal output terminals,
wherein the signal loading circuit comprises:
a first loading diode regulating current amount flowing from the second voltage supply terminal to the first signal output terminal in response to the first output signal;
a second loading diode regulating current amount flowing from the second voltage supply terminal to the second signal output terminal in response to the second output signal; and
a loading source regulating current amount flowing from the second voltage supply terminal to the second signal output terminal in response to the first output signal,
wherein an element, through which a current amount is regulated in accordance with variation in a voltage level of the second output signal, is excluded, the element being formed between the first signal output terminal and the second voltage supply terminal.

2. The differential amplifier as set forth in claim 1, wherein the second voltage supply terminal has a voltage higher than that of the first voltage supply terminal,
wherein the first loading diode is a first P-type transistor connected between the second voltage supply terminal and the first signal output terminal and flowing a current controlled by the first output signal,
wherein the second loading diode is a second P-type transistor connected between the second voltage supply terminal and the second signal output terminal and flowing a current controlled by the second output signal, and
wherein the loading source is a third P-type transistor connected between the second voltage supply terminal and the second signal output terminal and flowing a current controlled by the first output signal.

3. The differential amplifier as set forth in claim 2, wherein the first P-type transistor is a PMOS transistor having a source electrode connected to the second voltage supply terminal, a gate electrode to which the first output signal is applied, and a drain electrode connected to the first signal output terminal,
wherein the second P-type transistor is a PMOS transistor having a source electrode connected to the second voltage supply terminal, a gate electrode to which the second output signal is applied, and a drain electrode connected to the second signal output terminal, and
wherein the third P-type transistor is a PMOS transistor having a source electrode connected to the second voltage supply terminal, a gate electrode to which the first output signal is applied, and a drain electrode connected to the second signal output terminal.

4. The differential amplifier as set forth in claim 1, wherein the second voltage supply terminal has a voltage lower than that of the first voltage supply terminal,
wherein the first loading diode is a first N-type transistor connected between the second voltage supply terminal and the first signal output terminal and flowing a current controlled by the first output signal,
wherein the second loading diode is a second N-type transistor connected between the second voltage supply terminal and the second signal output terminal and flowing a current controlled by the second output signal, and
wherein the loading source is a third N-type transistor connected between the second voltage supply terminal and the second signal output terminal and flowing a current controlled by the first output signal.

5. The differential amplifier as set forth in claim 4, wherein the first N-type transistor is a NMOS transistor having a source electrode connected to the second voltage supply terminal, a gate electrode to which the first output signal is applied, and a drain electrode connected to the first signal output terminal,
wherein the second N-type transistor is a NMOS transistor having a source electrode connected to the second voltage supply terminal, a gate electrode to which the second output signal is applied, and a drain electrode connected to the second signal output terminal, and
wherein the third N-type transistor is a NMOS transistor having a source electrode connected to the second voltage supply terminal, a gate electrode to which the first output signal is applied, and a drain electrode connected to the second signal output terminal.

6. A differential amplifier providing first and second output signals having a voltage reference amplified from a voltage gap between first and second input signals, the differential amplifier comprising:
a first signal output terminal generating the first output signal;
a second signal output terminal generating the second output signal;
a common source terminal receiving a current from a first voltage supply terminal;
a first N-type transistor disposed between the first signal output terminal and the common source terminal and flowing a current controlled by the first input signal;
a second N-type transistor disposed between the first signal output terminal and the common source terminal and flowing a current controlled by the second input signal;
a first P-type transistor disposed between the second voltage supply terminal and the first signal output terminal and flowing a current controlled by the first output signal, the second voltage supply terminal having a voltage higher than that that of the first voltage supply terminal;
a second P-type transistor disposed between the second voltage supply terminal and the second signal output terminal and flowing a current controlled by the second output signal; and
a third P-type transistor disposed between the second voltage supply terminal and the second signal output terminal and flowing a current controlled by the first output signal,
wherein an element, through which a current amount is regulated in accordance with variation in a voltage level of the second output signal, is excluded, the element being formed between the first signal output terminal and the second voltage supply terminal.

7. The differential amplifier as set forth in claim 6, wherein the first P-type transistor is a PMOS transistor having a source electrode connected to the second voltage supply terminal, a gate electrode to which the first output signal is applied, and a drain electrode connected to the first signal output terminal,
wherein the second P-type transistor is a PMOS transistor having a source electrode connected to the second voltage supply terminal, a gate electrode to which the second output signal is applied, and a drain electrode connected to the second signal output terminal, and
wherein the third P-type transistor is a PMOS transistor having a source electrode connected to the second voltage supply terminal, a gate electrode to which the first output signal is applied, and a drain electrode connected to the second signal output terminal.

8. The differential amplifier as set forth in claim 6, which further comprises a current bias source disposed between the common source terminal and the first voltage supply terminal in order to supply a current to the common source terminal.

9. A differential amplifier providing first and second output signals having a voltage reference amplified from a voltage gap between first and second input signals, the differential amplifier comprising:
a first signal output terminal generating the first output signal;
a second signal output terminal generating the second output signal;
a common source terminal receiving a current from a first voltage supply terminal;
a first P-type transistor disposed between the common source terminal and the first signal output terminal and flowing a current controlled by the first input signal;
a second P-type transistor disposed between the common source terminal and the first signal output terminal and flowing a current controlled by the second input signal;
a first N-type transistor disposed between the first signal output terminal and the second voltage supply terminal and flowing a current controlled by the first output signal, the second voltage supply terminal having a voltage lower than that that of the first voltage supply terminal;
a second N-type transistor disposed between the second signal output terminal and the second voltage supply terminal and flowing a current controlled by the second output signal; and
a third N-type transistor disposed between the second signal output terminal and the second voltage supply terminal and flowing a current controlled by the first output signal,
wherein an element, through which a current amount is regulated in accordance with variation in a voltage level of the second output signal, is excluded, the element being formed between the first signal output terminal and the second voltage supply terminal.

10. The differential amplifier as set forth in claim 9, wherein the first N-type transistor is a NMOS transistor having a source electrode connected to the second voltage supply terminal, a gate electrode to which the first output signal is applied, and a drain electrode connected to the first signal output terminal,
wherein the second N-type transistor is a NMOS transistor having a source electrode connected to the second voltage supply terminal, a gate electrode to which the second output signal is applied, and a drain electrode connected to the second signal output terminal, and
wherein the third N-type transistor is a NMOS transistor having a source electrode connected to the second voltage supply terminal, a gate electrode to which the first output signal is applied, and a drain electrode connected to the second signal output terminal.

11. The differential amplifier as set forth in claim 10, which further comprises a current bias source disposed between the common source terminal and the first voltage supply terminal in order to supply a current to the common source terminal.

12. A differential amplifier, comprising:
first and second MOS input transistors responsive to first and second input signals, respectively;
a current source electrically connected to source terminals of said first and second MOS input transistors; and
a load circuit electrically coupled to drain terminals of said first and second MOS input transistors, said load circuit consisting essentially of:
a first MOS load transistor having gate and drain terminals electrically connected to a drain terminal of said first MOS input transistor and a source terminal configured to receive a power supply voltage;
a second MOS load transistor having a gate terminal electrically connected to the drain terminal of said first MOS input transistor, a drain terminal electrically connected to a drain terminal of said second MOS input transistor and a source terminal configured to receive the power supply voltage; and
a third MOS load transistor having gate and drain terminals electrically connected to the drain terminal of said second MOS input transistor and a source terminal configured to receive the power supply voltage.

13. The differential amplifier of claim 12, wherein said first and second MOS input transistors are NMOS transistors; and wherein said first, second and third MOS load transistors are PMOS transistors.

14. The differential amplifier of claim 12, wherein said first and second MOS input transistors are PMOS transistors; and wherein said first, second and third MOS load transistors are NMOS transistors.

15. The differential amplifier of claim 12, wherein the drain terminals of said first and second MOS input transistors represent first and second output terminals of the differential amplifier.
